(19) United States
(12) Patent Application Publication
(10) Pub. No.: US 2011/0119122 A1
(43) Pub. Date: May 19, 2011

(54) TRANSACTION PROCESSING METHOD AND SYSTEM

(75) Inventors: Amarjit S. Padam, Lexington, MA (US); Gaurav Mallik, Brookline, MA (US)

(73) Assignee: Payment Transaction Services, Inc., d/b/a CaptureCode, Waltham, MA (US)

(21) Appl. No.: 12/911,427

(22) Filed: Oct. 25, 2010

Related U.S. Application Data
(60) Provisional application No. 61/254,389, filed on Oct. 23, 2009.

(51) Int. Cl. G06Q 30/00

(52) U.S. Cl. 705/14.25; 705/26.1; 705/14.53

(57) ABSTRACT

A computer-implemented transaction processing method allows consumers to access offerings across a plurality of merchants using a single unique identification for each consumer. The method includes the steps of: (a) storing information on the consumers in a database including a unique identification associated with each of the consumers; (b) storing information on one or more merchant offerings from each of the plurality of merchants in a database; and (c) for each of the plurality of merchants: (i) receiving from a merchant over a communications network information on a proposed transaction with a consumer involving a merchant offering, the information including an identification of the merchant and the merchant offering, and the unique identification of the consumer; (ii) verifying that the unique identification of the consumer is valid and that the consumer is eligible to participate in the merchant offering, and transmitting an authentication and validation message to the merchant over the communications network; and (iii) receiving settlement information over the communications network from the merchant confirming that the merchant offering was applied to the transaction with the consumer, and storing the settlement information in a database.

### CROSS REFERENCE TO RELATED APPLICATION

This application claims priority from U.S. Provisional Patent Application Ser. No. 61/254,389, filed on Oct. 23, 2009, entitled TRANSACTION PROCESSING METHOD AND SYSTEM, which is hereby incorporated by reference.

### BACKGROUND

The present application is generally directed to transaction processing methods and systems that allow merchants to more effectively and efficiently provide offerings to consumers such as marketing promotions (e.g., coupons), loyalty and reward programs, and stored value card programs (e.g., prepaid gift cards and store credit). Methods and systems are also provided for an integrated payment system allowing consumers to access a variety of specialty services such as health care services at various provider facilities such as hospitals, pharmacies, outpatient clinics, or specialty healthcare service providers using a single unique identification.

### BRIEF SUMMARY OF THE DISCLOSURE

In accordance with one or more embodiments, a computer-implemented transaction processing method is provided allowing consumers to access offerings across a plurality of merchants using a single unique identification for each consumer. The method includes the steps of: (a) storing information on the consumers in a database including a unique identification associated with each of the consumers; (b) storing information on one or more merchant offerings from each of the plurality of merchants in a database; and (c) for each of the plurality of merchants: (i) receiving from a merchant over a communications network information on a proposed transaction with a consumer involving a merchant offering, the information including an identification of the merchant and the merchant offering, and the unique identification of the consumer; (ii) verifying that the unique identification of the consumer is valid and that the consumer is eligible to participate in the merchant offering, and transmitting an authentication and validation message to the merchant over the communications network; and (iii) receiving settlement information over the communications network from the merchant confirming that the merchant offering was applied to the transaction with the consumer, and storing the settlement information in a database.

In accordance with one or more embodiments, a computer-implemented transaction processing system is provided allowing consumers to access offerings across a plurality of merchants using a single unique identification for each consumer. The system comprises a computer server system in communication with client devices operated by the plurality of merchants over a communications network. The computer server system includes a database for storing information on the consumers including a unique identification associated with each of the consumers, and a database for storing information on one or more merchant offerings from each of the plurality of merchants. The computer server system is configured to: (a) receive from a merchant over the communications network information on a proposed transaction with a consumer involving a merchant offering, the information including an identification of the merchant and the merchant offering, and the unique identification of the consumer; (b) verify that the unique identification of the consumer is valid and that the consumer is eligible to participate in the merchant offering, and transmit an authentication and validation message to the merchant over the communications network; and (c) receive settlement information over the communications network from the merchant confirming that the merchant offering was applied to the transaction with the consumer, and store the settlement information in a database.

In accordance with one or more embodiments, a computer-implemented transaction processing method is provided allowing consumers to access healthcare services across a plurality of providers using a single unique identification. The method includes the steps of: (a) storing information on the consumers in a database including a unique identification associated with each of the consumers and an account loaded with health benefits and bank account or credit/debit card information; (b) storing information on one or more providers in a database; and (c) for each of the plurality of providers: (i) receiving from a provider over a communications network information on a proposed transaction with a consumer, the information including an identification of the provider and the unique identification of the consumer; (ii) verifying that the unique identification of the consumer is valid and charging the proposed transaction to the customer's account; and (iii) transmitting information over the communications network to the provider confirming settlement of the transaction.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a block diagram illustrating the high level architecture of a transaction processing system in accordance with one or more embodiments.

FIG. 2 is a flowchart illustrating registration of a new consumer with the transaction processing system in accordance with one or more embodiments.

FIG. 3 is a flowchart illustrating the process of in-store consumer registration in accordance with one or more embodiments.

FIG. 4A is a flowchart illustrating existing consumer registration on the transaction processing system portal in accordance with one or more embodiments.

FIG. 4B is a flowchart illustrating new consumer registration on the system portal in accordance with one or more embodiments.

FIG. 5 is a flowchart illustrating the process of issuing a gift card associated with a consumer's unique ID at a merchant's premises in accordance with one or more embodiments.

FIG. 6 is a flowchart illustrating the processing of an online purchase of a gift card in accordance with one or more embodiments.

FIG. 7 is a flow chart generally illustrating the process of setting up and running a promotion by a merchant using the transaction processing system in accordance with one or more embodiments.

FIG. 8 is a flowchart illustrating the processing of transactions by the system in accordance with one or more embodiments.

FIG. 9 is a flowchart illustrating use of a unique identification code by consumers for obtaining healthcare services in accordance with one or more embodiments.

FIGS. 10A-10C illustrate an example of a merchant handheld device used in processing transactions In accordance with one or more embodiments.

### DETAILED DESCRIPTION

As discussed in further detail below, methods and systems in accordance with one or more embodiments allow consumers to use a single unique identification (ID) for accessing various offerings across multiple participating merchants. (As used herein, the term “merchant” refers to any individual, business, organization, or other entity that provides products or services to consumers including, without limitation, shops, restaurants, pharmacies, healthcare facilities, and specialty service providers.) Offerings can include, without limitation, coupons, loyalty program points, or stored value card funds. A consumer initially registers with a transaction processing system to participate in offerings from one or more merchants. The transaction processing system assigns a unique ID to the consumer, which can be, e.g., in the form of a 2-D code, a bar code, or an alphanumeric code. The unique ID can be delivered to the consumer in various ways including, e.g., electronically by Internet download, email, SMS, MMS, picture attachment or any other digital media, or in tangible form such as in plastic or paper. A consumer can redeem offers, use prepaid cards, or collect loyalty points at a participating merchant by simply presenting his or her assigned unique ID. The merchant submits the unique ID information to the transaction processing system, which verifies that the ID is valid and that the consumer is eligible to participate in the merchant offering. In accordance with various embodiments, the transaction processing system can directly interact with the merchant's point-of-sale (POS) or point-of-care (POC) system and automatically apply offers, prepaid cards, or loyalty points to the consumer's transaction or deduct the amount related to purchased products or services from a consumer account.

The methods and systems in accordance with various embodiments provide numerous advantages for both merchants and consumers. For example, the transaction processing system provides a single ID for consumers that can be used for participating in offerings or services across multiple merchants or service providers. This is very convenient for consumers since they need to store just one ID for managing all coupons, loyalty points, store credit, and gift cards for different participating merchants or load funds from their bank account or credit card for to use at merchants and service providers. The consumer ID can be conveniently stored in tangible form (e.g., on a plastic or paper medium) or as an image on an electronic device operated by consumers, preferably without requiring the consumer to download an application on the device.

The transaction processing system provides cost savings for merchants by combining and reducing the cost of managing different merchant loyalty, gift, and marketing promotions. In addition, most conventional coupons require some form of clearing and settlement, typically carried out by a third party. The transaction processing system in accordance with various embodiments automatically clears and settles coupons when redeemed, thereby reducing clearing and settlement costs for merchants. The transaction processing system can also be used to settle and clear healthcare payment using the same code that identifies the consumers upon registration with healthcare payers.

In addition, because the transaction processing system can be integrated with retail POS or POC systems, merchants/providers can quickly and easily determine the incremental value generated by running marketing programs.

The transaction processing system can also reduce fraud by providing an extensive audit trail for all functions and the ability to monitor and control individual offers and devices.

The transaction processing system also allows merchants to target promotional offers to individual consumers or groups of consumers based on, e.g., demographic information provided by the consumers or past user redemption activity or other user behavior.

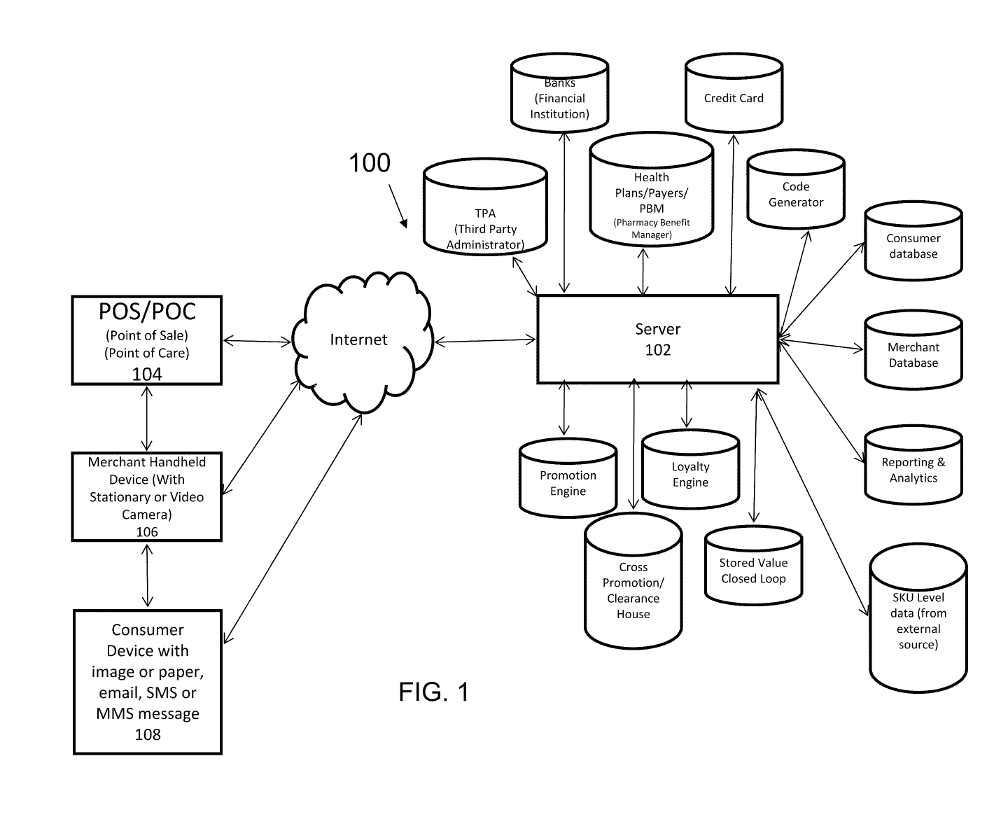

FIG. 1 is a block diagram illustrating the high level architecture of a transaction processing system in accordance with one or more embodiments. The transaction processing system includes a server 102, which communicates with a plurality of backend services over a network.

The backend services can include one or more of the following:

Promotion Engine: The backend promotion engine is a database for storing promotions, including current and future promotions. New promotions to be launched are stored in this database. In addition, a history of past promotions can be stored for online access by merchants. The promotion engine also handles the active/current promotions redemption by validating the request from the merchant handheld devices 106.

Cross Promotion/Clearance House: This backend database is used for hosting cross promotions for different merchants participating in cross marketing promotions administered by transaction processing system. The transaction processing system facilitates all transactions related to cross promotions between different merchants and loyalty points, rewards, and redemptions facilitated by this engine.

Loyalty Engine: This engine keeps track of loyalty programs (active and non active) for a given merchant or across merchants for loyalty points based on program offerings by merchants. This engine add points and calculates dollar value conversions on a real-time basis.

Stored Value Closed Loop: This engine keeps track of all active stored value gift cards. This engine validates, authenticates, and authorizes all transactions for stored value cards.

Consumer Database: This database maps unique customer IDs to their optional demographic information. This database holds relevant information about consumers, about their past redeemed promotions or transactions related to loyalty points, store credit, and gift cards.

Merchant Database: The merchant database holds information about merchants such as merchant offerings through the transaction processing system, POS/POC system information, and other CRM integration with the Merchant database. The merchant user configuration and profile management are preferably kept encrypted in this database.

Reporting and Analytics: This database holds data related to consumers, merchants, and offerings in order to generate real-time pre-defined reports or custom/adhoc reports as requested.

SKU Level Data: This database holds SKU level data for merchandise of participating merchants for marketing promotions at the SKU level and adjudicates these transactions at the SKU level on a real-time basis using merchant handheld devices.

Code Generator: Upon customer registration for loyalty programs, special promotions, store credit, stored value gift card, health care benefits, this engine generate a unique code for each consumer or a different code for each e-voucher for single or multiple use by family or friends. E-voucher/coupons distributed thru FSI (Free Standing Inserts) and newspapers could be identified with a unique ID code and be adjudicated on a real-time basis.

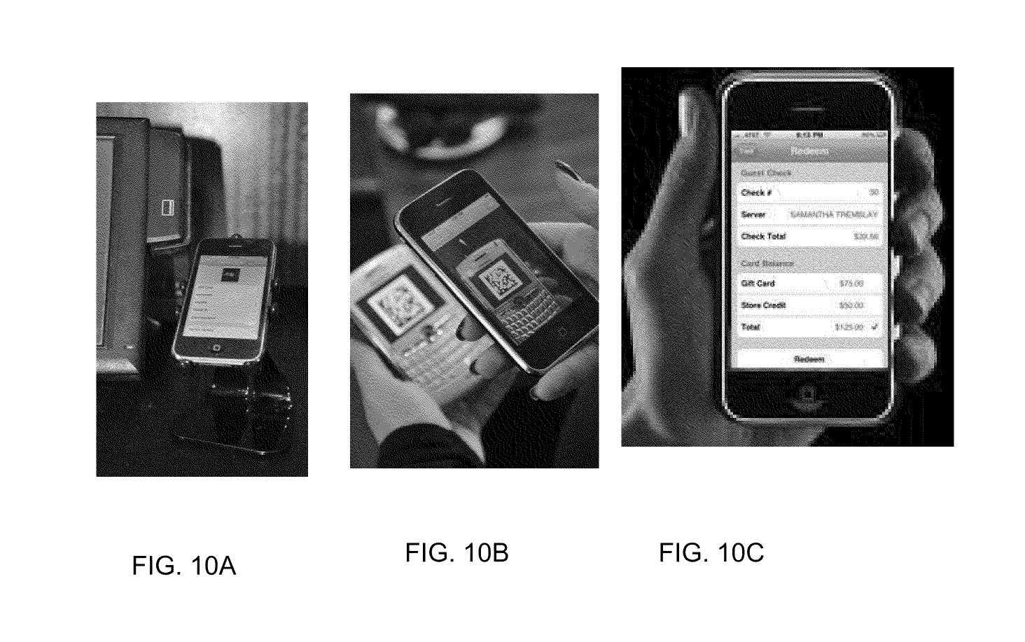

The server 102 also communicates with one or more merchant handheld devices 106 operated by personnel at various participating merchants over a communications network such as the internet or a cellular network. The merchant handheld device 106 can be, e.g., a smart device (such as a phone, webcam or other similar device) with camera or video camera or smart scanner. FIGS. 10A-10C illustrate an example of a merchant handheld device 106, in this case an iPhone smartphone configured to perform the functions described herein. The merchant handheld device 106 can be connected to the merchant POS/POC system 104 in a wired or wireless connection (e.g., Internet, cellular network, local area network) as shown in FIG. 10A. The merchant handheld device 106 is used to capture and image of unique consumer ID when presented by the consumer, e.g., from a display on the consumer's phone or other mobile device 108 (as shown in FIG. 10B), or from an ID printed on plastic or paper. Alternately, the consumer's unique identifier can be manually keyed into the merchant handheld device 106. The merchant handheld device 106 transmits the consumer's unique ID information to the server 102 preferably in the form of an encrypted message over a secured channel. The server 102 processes the request in real-time using one or more backend services for authentication and adjudication. Once the consumer's unique ID has been authenticated and eligibility to participate in the offering verified, the server 102 sends a message to the merchant handheld device 106, which submits the response into the merchant POS/POC system 104 for settlement processing. After the settlement, the merchant handheld device 106 captures the POS/POC data from the completed transaction, and sends the data to the server 102 for the real-time reporting, analytics, and future trigger events for consumers and merchants across different verticals.

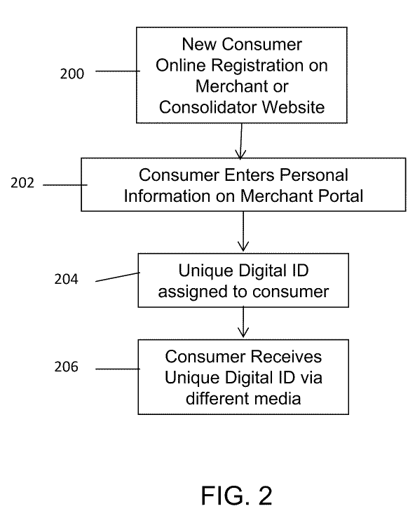

FIG. 2 is a flowchart illustrating registration of a new consumer with the transaction processing system. Consumers can register on an individual participating merchant or system website to receive a unique identifier code. Consumers can provide demographic information and indicate how they would like to receive subsequent messages from merchant or the transaction processing system. Consumers can opt-in for to receive subsequent promotional messages.

At step 200, a consumer enters a merchant or system website for online registration. The consumer can click on a link on the website, which will direct the consumer to a merchant or system portal. The merchant or system portal can be hosted by the transaction processing system or independently by the merchant or system.

At step 202, the consumer enters personal demographic information such as first and last names, email, and zip code and other relevant information such as favorite food, allergies (including food allergies), and other health related information. The consumer can also optionally enter information on his or her date of birth, date of anniversary, preferences such as favorite drinks, and a mobile number to receive SMS or MMS message on their mobile phone. The consumer can also enter information on preferred brands or types of promotions he or she would like to receive.

At step 204, the server 102 receives the information entered by the consumer and determines whether the consumer information comprises valid inputs. The server 102 also conducts various audits on a real-time basis. (The communication between the merchant or system websites and server 102 is preferably encrypted and transmitted over the secured channels.) Once the information is deemed to be a valid input, the server 102 stores the information into the consumer database and assigns a unique digital identifier for consumer.

At step 206, the consumer receives the unique identifier by email, SMS, MMS, plastic or paper or any other digital or analog media. The unique identifier is also downloadable from the Internet and accessible with a temporary password provided to the consumer. The consumer can also receive current promotions and information on any loyalty points earned for registration. The registration process is completed once the consumer receives the unique digital ID.

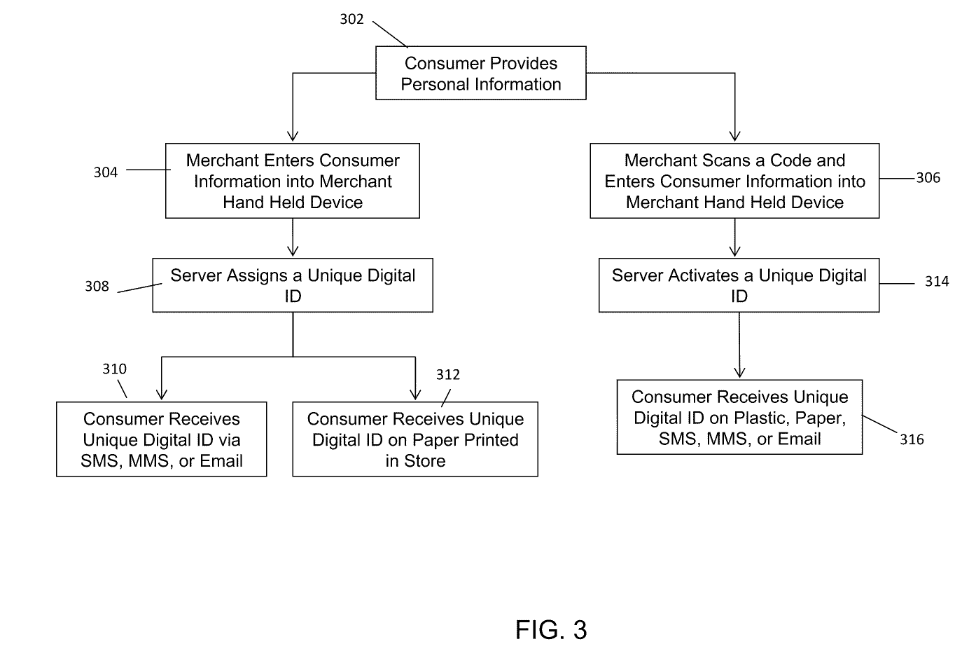

A consumer can also register with the system in-store, i.e., at the merchant's premises, as illustrated in the flow chart of FIG. 3. At step 302, the consumer provides personal information (the demographic information described above with respect to FIG. 2). The merchant enters this information into the merchant's handheld device 106, which is integrated with the merchant POS 104 at step 304. Alternately, the merchant scans an unactivated unique ID and then enters the information in the handheld device 106 at step 306. The information is transmitted to the server 102, which processes the information and assigns a unique digital ID to the consumer at step 308 or activates the unique digital ID code scanned by the merchant at step 314. The new consumer then receives the unique digital ID sent by the server 102 via SMS, MMS, and/or email if provided by the consumer at step 310 or the consumer may chose to receive it on paper printed in the store by the merchant at step 312. In case of activation of the ID, the consumer may receive it on plastic in addition to any of the other methods such as paper, SMS, MMS, or email at step 316. The registration process is completed once the consumer receives the unique digital ID.

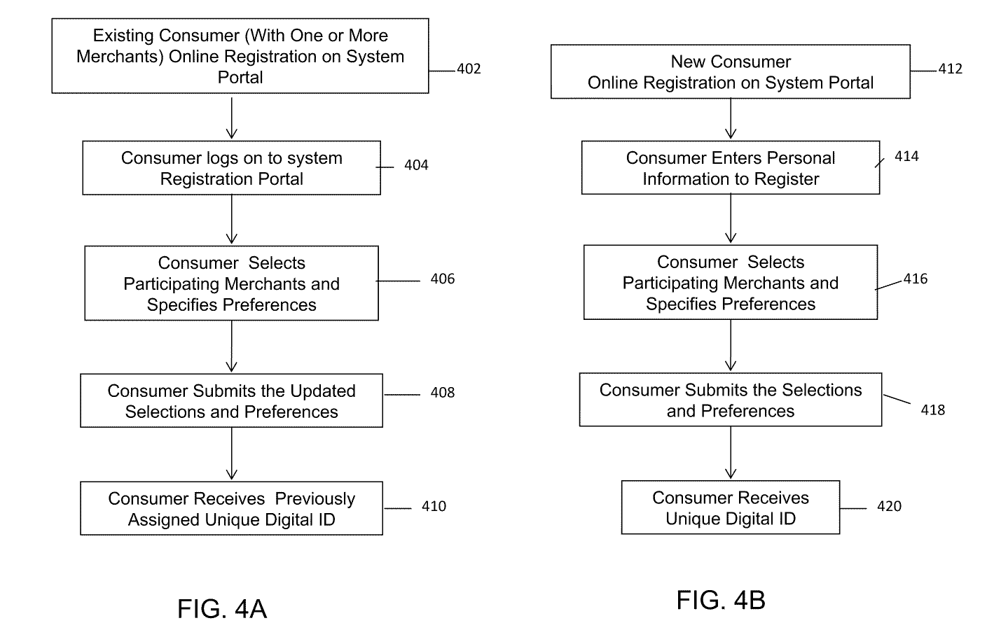

FIG. 4A is a flowchart illustrating existing consumer registration on the transaction processing system portal. At step 402, an existing consumer who is already registered with one or more merchants may register online with additional merchants on the system portal.

At step 404, the consumer logs on to the transaction system registration portal using a number associated with a unique ID or a user name and password.

At step 406, once logged on to the transaction system portal, the consumer may choose to select or unselect participating merchants and specify individual preferences for receiving promotions or edit or update his or her own personal information.

At step 408, the consumer submits the information, and it is transmitted to the system server 102.

At step 410, the server 102 sends the previously assigned unique digital ID to the consumer via SMS, MMS, or email, and the registration process is completed.

FIG. 4B is a flowchart illustrating new consumer registration on the system portal. At step 412, a new consumer begins an online registration process with one or more merchants on the transaction system portal.

At step 414, the consumer enters personal information on the transaction system registration portal.

At step 416, the consumer may chose to select one or more participating merchants and specify individual preferences for receiving promotions.

At step 418, the consumer submits the information, and it is transmitted to the transaction system server 102.

At step 420, the transaction system server 102 assigns and sends a unique digital ID to the consumer via SMS, MMS, or email and the registration process is completed. The unique ID can also be sent to the consumer in paper or plastic form.

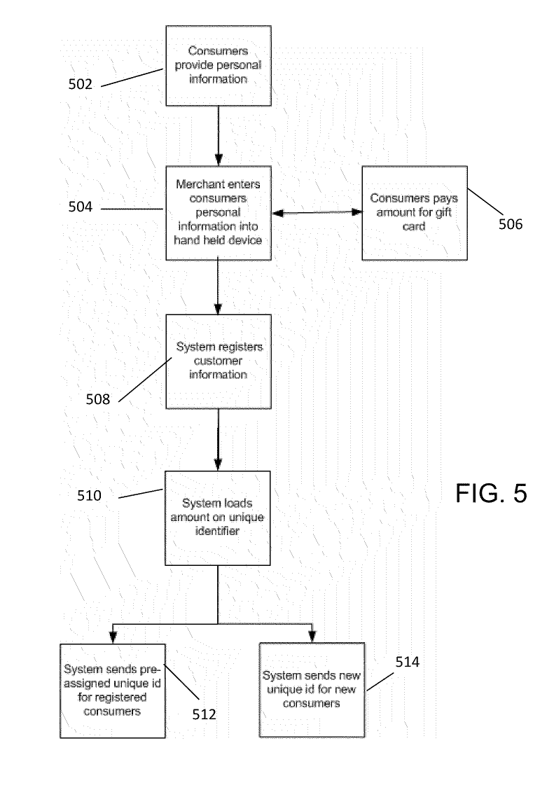

FIG. 5 is a flowchart illustrating the process of issuing a gift card associated with a consumer's unique ID at the merchant premises. At step 502, the consumer provides personal and demographic information (of the type discussed above) to the merchant. At step 504, the merchant enters the consumer personal information into the system. The consumer pays for the gift card at step 506, and the merchant enters payment information (cash or Credit or debit transaction).

For a Credit/Debit Card transaction, the merchant enters the credit card information into the merchant handheld device 106 by manually entering the credit/card information or swiping the card through a magnetic card reader attached to the handheld device 106. The merchant also takes a picture of the 2-D code unique identifier from a card to be issued to the consumer. The credit/debit card information is submitted for payment authorization.

At step 508, after a successful payment clearance message from the processor, the transaction processing system registers the consumer using the personal and demographic information entered. The transaction processing system registers this information with payment.

At step 510, the transaction processing system applies the payment amount to an account associated with the unique identifier.

At steps 512 and 514, the transaction processing system sends the unique identifier, which has been preloaded with the payment amount, to consumer for immediate use via email, SMS, MMS, picture attachment, or any other digital media over the internet or via cellular or other communications networks to the user's personal digital device 108.

In a similar manner, consumers can register with the system online to receive gift cards. Consumers can also load their unique identifier with the value to be used at participating merchants using credit/debit cards, bank ATM/ACH transactions, or any other current or future developed transactions.

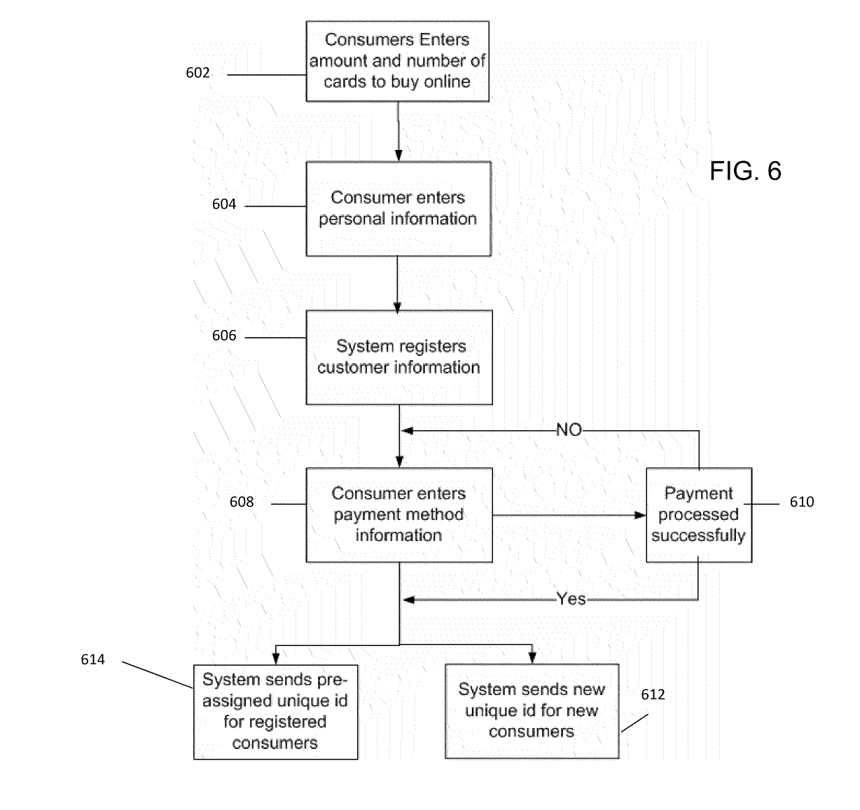

FIG. 6 is a flowchart illustrating the processing of an online purchase of a gift card in accordance with one or more embodiments. Consumers can buy a system branded or participating merchant branded electronic gift card online.

At step 602, the consumer enters the number of cards and card value for each card. At step 604, the consumer enters his or her personal and demographic information as previously discussed. At step 606, the transaction processing system registers the consumer information entered. At step 608, the consumer enters payment information (e.g., credit or debit card number or bank account number). At step 610, the transaction processing server 102 seeks authorization of the debit or credit card or banking system payment. If the payment is processed successfully, then at step 612, the transaction processing system generates new unique ID for the consumer if the consumer is a new user, associates the ID with the approved payment amount, and sends the ID to the consumer by e-mail, SMS, MMS, or other digital media. The consumer can also download the ID from a website. Consumer can send the digital code to their friends and others electronically with loaded cash as a gift for their use at all participating merchants.

Alternately, if this consumer is already a registered user based on prior registration with the transaction processing system or any participating merchant, the previously assigned unique digital id will be loaded with approved amount for immediate use at step 614. The digital card can be sent to the consumer by e-mail, SMS, MMS, or other digital media. The consumer can also download the ID from a website.

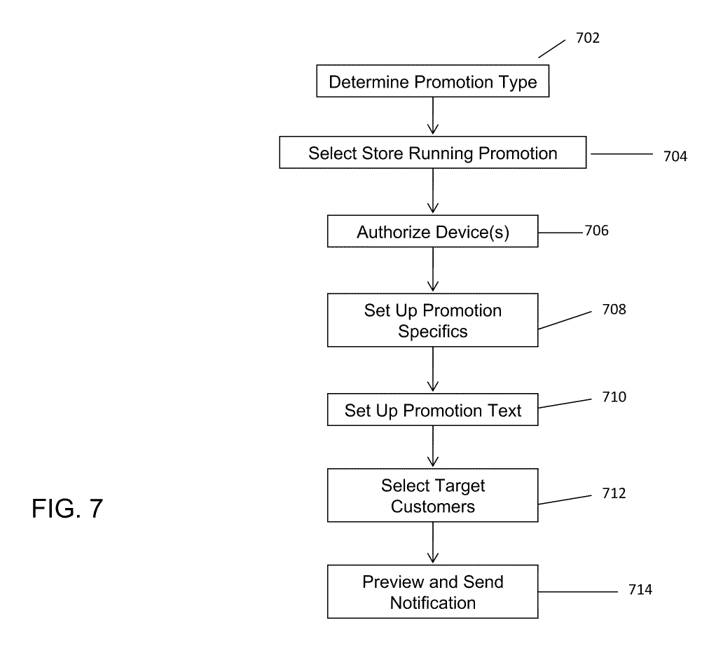

FIG. 7 is a flow chart generally illustrating the process of setting up and running a promotion by a merchant using the transaction processing system in accordance with one or more embodiments.

At step 702, the merchant determines the type of promotion to run, e.g., providing eVoucher or coupons to consumers or a holding a drawing. At step 704, the merchant selects the store(s) to run the promotion in, assuming there are multiple stores associated with the merchant. At step 706, the merchant authorizes the merchant handheld devices to be used for redeeming/recognizing promotions.

At step 708, the merchant sets up the specifics and details of the promotion such as, e.g., the start date, end date, recurrence, usage limit, etc.

At step 710, the merchant sets up the message or text to be sent to the consumers describing the promotion.

At step 712, the merchant selects the target consumers, assuming only a selected group of consumers are to receive the offer. The promotion set up is completed.

At step 714, the merchant can preview the promotion details and message before sending the notification to the previously selected consumers or edit the promotional details or the target consumers, if desired, before launching the promotion.

Consumers can check the status of their accounts online. Consumers can log on to the merchant portal by using the number associated with their unique digital ID or username and a password. Consumers can check their account balances (promotions available, promotion redeemed, loyalty points earned, rewards available, store credit and gift card amount). Consumers can also update their demographic information to earn rewards or other benefits or opt in to receive future promotions via digital or analog methods on their electronic devices 108. Consumers also have the option to reset their password and export all past and current activities to their electronic devices 108.

Consumers can also log on to the transaction system portal using the number associated with their unique digital ID or a username and a password. Consumers can check their account balances (promotions available, promotion redeemed, loyalty points earned, rewards available, store credit and gift card amount) across all participating merchant over transaction system network. Consumers can also update their demographic information to earn rewards or other benefits or opt in to receive their future promotions via digital or analog methods on their digital devices 108. In addition, consumers can select or deselect participating merchants and specific future promotions to be attached to their unique digital ID.

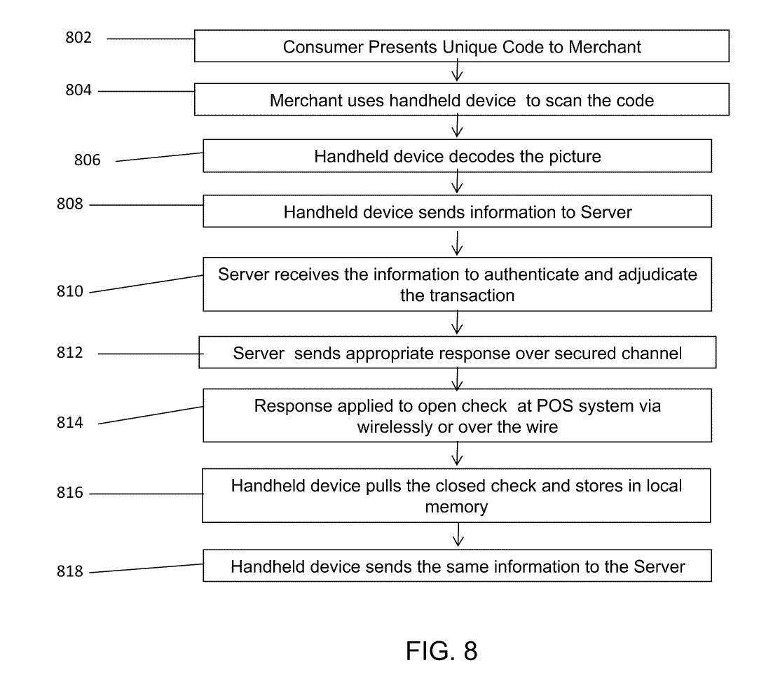

FIG. 8 is a flowchart illustrating the processing of transactions by the system. At step 802, a consumer seeking to redeem a promotion or a gift card or participate in a loyalty program presents his or her unique digital ID to the merchant.

At step 804, the merchant uses a merchant handheld device 106 to scan the code by taking a picture of the code. As discussed above, the merchant handheld device 106 is integrated with the merchant's POS or POC system 104.

At step 806, the merchant handheld device 106 decodes the picture. At step 808, the merchant handheld device 106 sends the decoded information on the unique digital ID to the server 102.

At step 810, the server 102 receives the information from the handheld device 106 for authentication and validation. The server identifies the information as coming from valid handheld device 106 with proper merchant information and time stamps the message. The server processes this message by decoding the encrypted message and validating the message. The server logs the message and passes it through a rules engine. The rules engine validates the information and prepares a response.

At step 812, the server encodes the response and sends this message over the secured network to the merchant handheld device 106 for front end processing. The merchant handheld device 106 receives the encoded message, decodes the message, time stamps the message, and displays information from the server on the screen.

At step 814, the merchant handheld device 106 pulls information from the merchant POS/POC system 104 related to the current basket or transaction for the consumer and applies the appropriate discount, amount, reward or any other information that was approved by server 102. The handheld device 106 can communicate with the POS/POC 104 through a wired or wireless connection.

At step 816, merchant handheld device 106 also pulls all the information relating to the completed transaction with the consumer from the POS/POC 104 and stores in local memory for future processing.

At step 818, the merchant handheld device 106 sends all the information relating to the completed consumer transaction to the server 104, which can report back to the merchant information on daily activities and future promotions effectiveness.

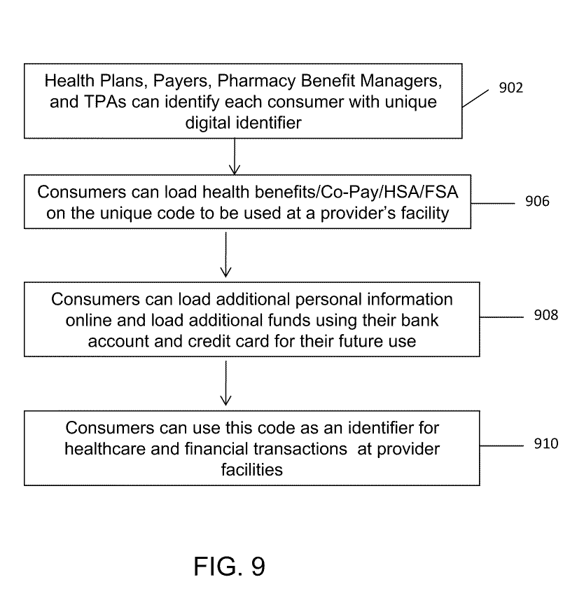

FIG. 9 is a flowchart illustrating use of a unique identification code by consumers for obtaining healthcare services in accordance with one or more embodiments. At step 902, a consumer is assigned a unique code for use in obtaining healthcare services. In one or more embodiments, the same unique identification code described above for accessing offerings from merchants can be used for obtaining healthcare services. The unique identification code will be used to identify consumers by health plans, payers, pharmacy benefit managers, and third-party administrators. Consumers can use their identification code as an ID for getting health benefits at various providers including medical facilities, labs, and pharmacies and from healthcare providers. In accordance with one or more embodiments, consumers can load important vital signs or other healthcare information or family medical history on the unique code. Such information can be subsequently accessed by health care providers.

Consumer can pay for healthcare services with pre-loaded funds and/or healthcare accounts. At step 906, consumers can load health benefits, co-pay information, and HSA/FSA (health savings account/flexible spending account) information on their unique codes.

At step 908, consumers can upload funds on their unique identification codes with credit/debit cards and bank account transactions for their use at all providers across verticals.

At step 910, consumers can use their unique identification codes as identification to receive healthcare services and to make payment at a point of care system. Payment can be made for out of pocket expenses or other related expenses that are not covered by payers (healthcare insurance company) by providing the patient's identification code to the service provider.

In accordance with one or more embodiments, merchants can also use mobile devices as a standalone device to conduct various types of transactions between consumers and merchants. In such embodiments, transactions can be conducted without the use of a POS/POC system.

In accordance with one or more further embodiments, a behavioral rewards program is provided to reward consumers for exhibiting particular desired behavior. For example, consumers can be rewarded for purchasing healthy food products at restaurants and supermarkets or for utilizing a health club. The consumer's unique identification code can be used to track user behavior at participating merchants and for receiving rewards.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

What is claimed is:

1. A computer-implemented transaction processing method allowing consumers to access offerings across a plurality of merchants using a single unique identification for each consumer, the method comprising:
(a) storing information on the consumers in a database including a unique identification associated with each of the consumers;
(b) storing information on one or more merchant offerings from each of the plurality of merchants in a database; and
(c) for each of said plurality of merchants:
(i) receiving from a merchant over a communications network information on a proposed transaction with a consumer involving a merchant offering, said information including an identification of the merchant and the merchant offering, and the unique identification of the consumer;
(ii) verifying that the unique identification of the consumer is valid and that the consumer is eligible to participate in the merchant offering, and transmitting an authentication and validation message to the merchant over the communications network; and
(iii) receiving settlement information over the communications network from the merchant confirming that the merchant offering was applied to the transaction with the consumer, and storing the settlement information in a database.

2. The method of claim 1 further comprising processing the settlement information for analytics and reporting.

3. The method of claim 1 further comprising determining buyer behavior of the consumer based on the settlement information for the consumer, and transmitting offers to the consumer that are customized based on buyer behavior.

4. The method of claim 1 wherein the unique identification comprises a 2-D code, a bar code, or other digital code or an alphanumeric code.

5. The method of claim 1 further comprising transmitting the unique identification to each consumer by e-mail, SMS, MMS, or an Internet download, or in plastic or paper.

6. The method of claim 1 wherein the information on the consumers further comprises consumer demographic information, and the method further comprises transmitting offers from merchants to consumers that are customized based on the consumer demographic information.

7. The method of claim 1 wherein the merchant offerings comprise coupons, loyalty program points, or stored value card funds.

8. The method of claim 1 further comprising enabling consumers to select merchants, edit preferences for merchant offerings, or check balances relating to merchant offerings for which they are registered.

9. The method of claim 1 further comprising utilizing the unique identification for each of said consumers as an account to pay for healthcare services.

10. The method of claim 1 further comprising rewarding a consumer for exhibiting particular desired behavior, said behavior being tracked by use of the unique identification.

11. A computer-implemented transaction processing system allowing consumers to access offerings across a plurality of merchants using a single unique identification for each consumer, the system comprising a computer server system in communication with client devices operated by the plurality of merchants over a communications network, said computer server system including a database for storing information on the consumers including a unique identification associated with each of the consumers, and a database for storing information on one or more merchant offerings from each of the plurality of merchants, said computer server system being configured to:
(a) receive from a merchant over the communications network information on a proposed transaction with a consumer involving a merchant offering, said information including an identification of the merchant and the merchant offering, and the unique identification of the consumer;
(b) verify that the unique identification of the consumer is valid and that the consumer is eligible to participate in the merchant offering, and transmit an authentication and validation message to the merchant over the communications network; and
(c) receive settlement information over the communications network from the merchant confirming that the merchant offering was applied to the transaction with the consumer, and store the settlement information in a database.

12. The system of claim 11 wherein the computer server system is further configured to process the settlement information for analytics and reporting.

13. The system of claim 11 wherein the computer server system is further configured to determine buyer behavior of the consumer based on the settlement information for the consumer, and to transmit offers to the consumer that are customized based on buyer behavior.

14. The system of claim 11 wherein the unique identification comprises a 2-D code, a bar code, or other digital code or an alphanumeric code.

15. The system of claim 11 wherein the computer server system is further configured to transmit the unique identification to each consumer by e-mail, SMS, MMS, or an Internet download, or in plastic or paper.

16. The system of claim 11 wherein the information on the consumers further comprises consumer demographic information, and the computer server system is further configured to transmit offers from merchants to consumers that are customized based on the consumer demographic information.

17. The system of claim 11 wherein the merchant offerings comprise coupons, loyalty program points, or stored value card funds.

18. The system of claim 11 wherein the computer server system is further configured to further enable consumers to select merchants, edit preferences for merchant offerings, or check balances relating to merchant offerings for which they are registered.

19. The system of claim 11 wherein the computer server system is further configured to utilize the unique identification for each of said consumers as an account to pay for healthcare services.

20. The system of claim 11 wherein the merchant client devices comprise wireless handheld devices or point of sale or point of care systems.

21. A computer-implemented transaction processing method allowing consumers to access healthcare services across a plurality of providers using a single unique identification, the method comprising:
(a) storing information on the consumers in a database including a unique identification associated with each of the consumers and an account loaded with health benefits and bank account or credit/debit card information;
(b) storing information on one or more providers in a database; and
(c) for each of said plurality of providers:
(i) receiving from a provider over a communications network information on a proposed transaction with a consumer, said information including an identification of the provider and the unique identification of the consumer;
(ii) verifying that the unique identification of the consumer is valid and charging said proposed transaction to the customer's account; and
(iii) transmitting information over the communications network to the provider confirming settlement of the transaction.

22. The method of claim 21 wherein the account for each consumer further comprises insurance plan co-payment information and health savings account or flexible spending account information.

23. The method of claim 21 further comprising storing healthcare information relating to the consumer on his or her unique code such that said information can be accessed by providers.
